(19) United States
(12) Patent Application Publication
(10) Pub. No.: US 2018/0062405 A1
(43) Pub. Date: Mar. 1, 2018

(54) ADJUSTABLE CHARGING BASE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN-FA ZHAO, Shenzhen (CN)

(21) Appl. No.: 15/691,753

(22) Filed: Aug. 31, 2017

(30) Foreign Application Priority Data
Aug. 31, 2016 (CN) 201610775857.X

(51) Int. Cl. H02J 7/00

(52) U.S. Cl. CPC H02J 7/0044

(57) ABSTRACT

An adjustable charging base for charging an electronic device includes an upper cover defining a first opening therein and configured for holding an electronic device, and a lower cover having a receiving space defined therein. An interface connecting assembly includes at least two charging interfaces and is rotationally received in the receiving space. The interface connecting assembly is rotatable to provide one of the at least two charging interfaces through the first opening of the upper cover.

### CROSS-REFERENCE TO RELATED APPLICATIONS

This application claims priority to Chinese Patent Application No. 201610775857.X filed on Aug. 31, 2016, the contents of which are incorporated by reference herein.

### FIELD

The subject matter herein generally relates to an adjustable charging base for charging an electronic device.

### BACKGROUND

Generally, an electronic device requires a certain type of charger for charging and cannot be charged by other types of chargers.

### BRIEF DESCRIPTION OF THE DRAWINGS

Implementations of the present technology will now be described, by way of example only, with reference to the attached figures.

FIG. 1 is an assembled, isometric view of an embodiment of an adjustable charging base.

FIG. 2 is an exploded view of the adjustable charging base of FIG. 1.

FIG. 3 is an exploded view of an interface connecting assembly of FIG. 2.

FIG. 4 is an isometric view of the adjustable charging base in use for charging an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

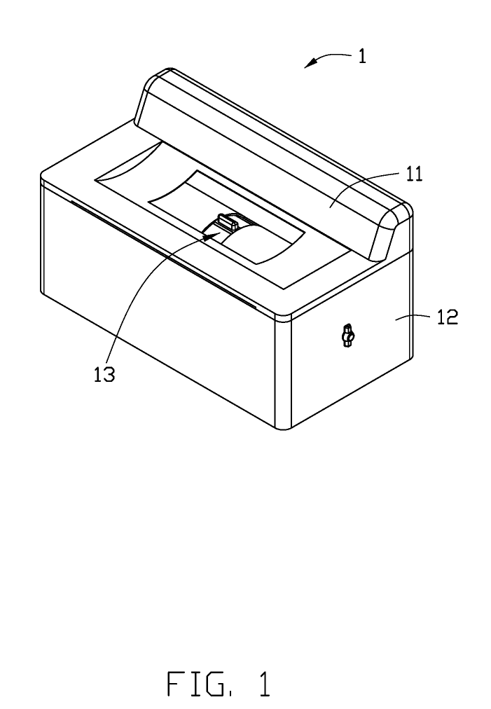

Referring to FIG. 1, an overall schematic view of an exemplary embodiment of an adjustable charging base 1 is shown. The adjustable charging base 1 can include an upper cover 11, a lower cover 12, and an interface connecting assembly 13. The upper cover 11 and the lower cover 12 can be sealed together.

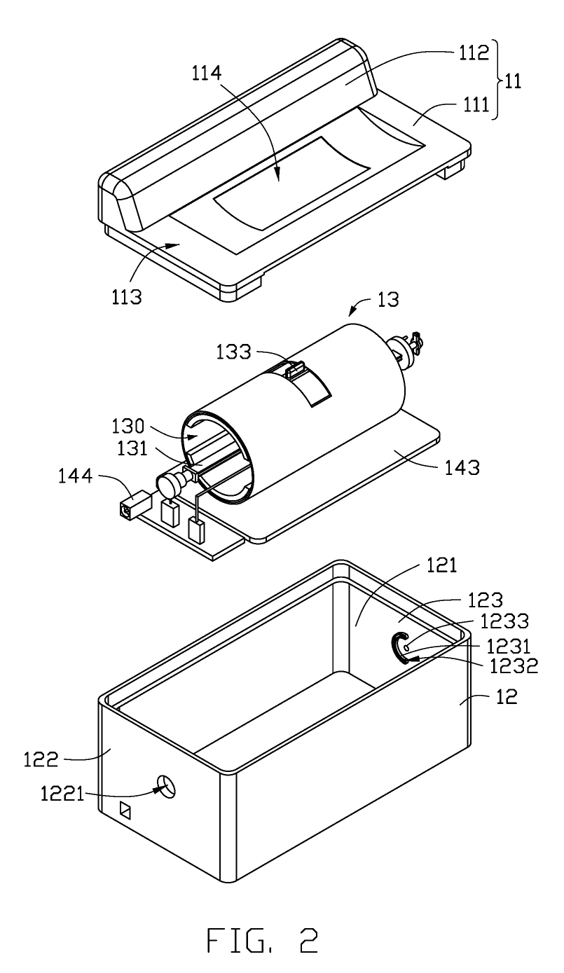

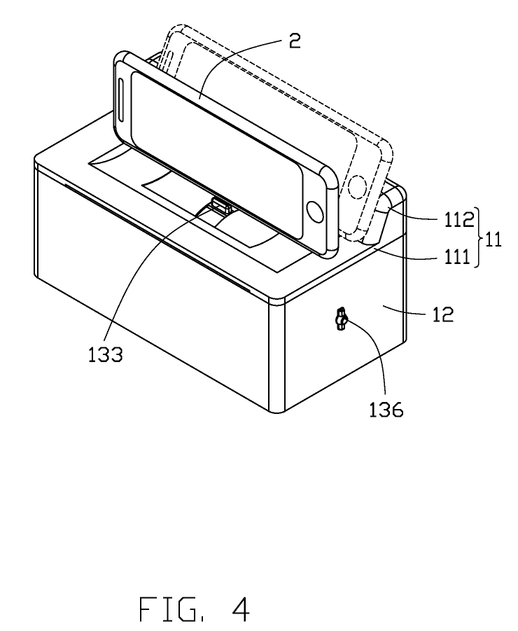

Referring to FIG. 2, the upper cover 11 can include a holding section 111 and a supporting section 112 extending upwardly from the holding section 111. A first accommodation space 113 can be cooperatively defined between the holding section 111 and the supporting section 112. An electronic device 2 (shown in FIG. 4) can be placed in the first receiving space 113. A first opening 114 can be defined in the holding section 111. A second receiving space 121 can be defined in the lower cover 12. The second receiving space 121 can receive the interface connecting assembly 13 therein. The lower cover 12 can be a closed casing having one end open. The lower cover 12 can include a first side wall 122 and a second side wall 123 opposite to the first side wall 122.

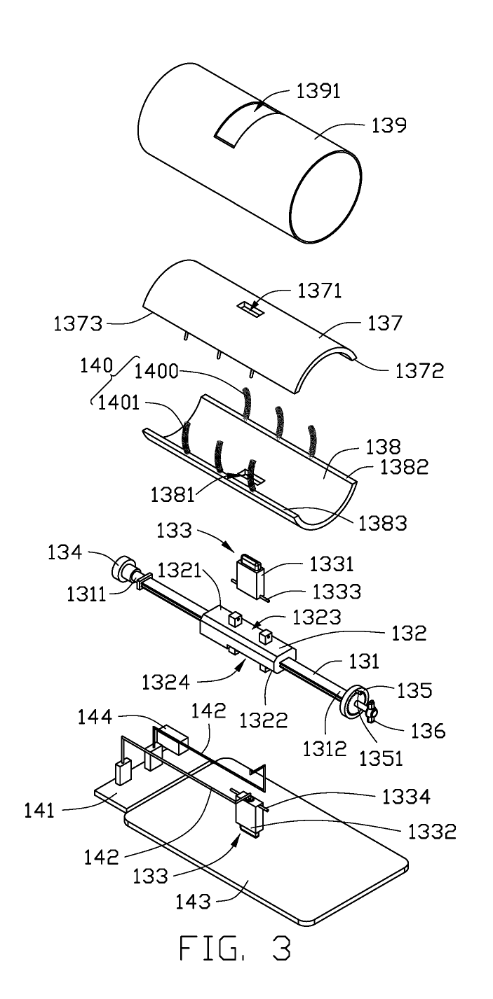

Referring to FIGS. 2 and 3, the interface connecting assembly 13 can include a sliding rail 131, a sliding block 132, and two charging interfaces 133. The sliding rail 131 can be rotationally disposed between the first side wall 122 and the second side wall 123. The sliding block 132 is mounted on the sliding rail 131 and is slidable with respect to the sliding rail 131. The two charging interfaces 133 can be rotationally coupled to the sliding block 132. When the sliding rail 131 is rotated, the adjustable charging base 1 is switched from a first state in which one of the two charging interfaces 133 extends through the first opening 114 to a second state in which the other one of the two charging interfaces 133 extends through the first opening 114.

In detail, the interface connecting apparatus 13 further includes a first roller 134, a second roller 135, and a knob 136. The first side wall 122 can be provided with a first through hole 1221, and the first roller 134 can be received in the first through hole 1221 of the first side wall 122. The second side wall 123 can be provided with a boss 1231 on which an arcuate groove 1232 is defined. The second roller 135 is provided with a handle 1351. The handle 1351 of the second roller 135 is accommodated in the arcuate groove 1232 of the boss 1231 so that the engagement of the handle 1351 with the curved chute 1232 causes the second roller 135 and the sliding rail 131 to rotate relative to the boss 1231.

In the present embodiment, the boss 1231 is arcuate, and the boss 1231 and the arcuate chute 1232 have a curvature of 180 degrees to control the rotation direction and the rotation angle of the second roller 135. The sliding rail 131 includes a first end 1311 and a second end 1312. The first end 1311 of the sliding rail 131 is coupled to the first side wall 122 through the first roller 134. The second end 1312 is coupled to the second roller 135. The second through hole 1233 is defined at a substantially central position of the arc of the boss 1231 on the second side wall 123. The knob 136 is coupled to the second roller 135 and extends through the second through hole 1233. The knob 136 is used to drive the second roller 135 to rotate, and the sliding rail 131 and the sliding block 132 mounted on the sliding rail 131 are rotated along with the second roller 135.

In the present embodiment, the sliding block 132 includes a first side 1321 and a second side 1322 opposite to the first side 1321. The two charging interfaces 133 include a first charging interface 1331 and a second charging interface 1332. The first charging interface 1331 is coupled to the first side 1321, and the second charging interface 1332 is coupled to the second side 1322. In detail, the first charging interface 1331 can include a first connecting shaft 1333, and the second charging interface 1332 can include a second connecting shaft 1334. The first side 1321 is provided with a first U-shaped groove 1323, and the second side 1322 is provided with a second U-shaped groove 1324. The first charging interface 1331 is rotationally coupled to two opposite groove walls of the first U-shaped groove 1323 through the first connecting shaft 1333. The second charging interface 1332 is rotationally coupled to two opposite groove walls of the second U-shaped groove 1324 through the second connecting shaft 1334. In the present embodiment, the first charging interface 1331 is a USB interface, and the second charging interface 1332 is a LIGHTNING interface.

In the present embodiment, the interface connecting assembly 13 further includes a first housing 137, a second housing 138, a protective case 139, and a plurality of resilient members 140. The first housing 137 and the second housing 138 can be elastically coupled together by the plurality of resilient members 140. In the present embodiment, the first housing 137 can include a first end portion 1372 and a second end portion 1373, and the second housing 138 can include a third end portion 1382 and a fourth end portion 1383. The resilient members 140 can include resilient members 1400 and 1401. The first end portion 1372 of the first housing 137 is coupled to the third end portion 1382 of the second housing 138 by the resilient members 1400. The second end portion 1373 of the first housing 137 is coupled to the fourth end portion 1383 of the second housing 138. The protective case 139 is provided on the exterior of the first housing 137 and the second housing 138 to prevent misalignment when the first housing 137 and the second housing 138 are moved relative to each other. The first charging interface 1331 is coupled to the first housing 137. The second charging interface 1332 is coupled to the second housing 138.

In detail, the protective case 139 is a substantially cylindrical hollow structure, and the first housing 137 and the second housing 138 are arcuate. The first housing 137 and the second housing 138 together define a third receiving space 130 (see FIG. 2). The third receiving space 130 accommodates the sliding block 132. The first housing 137 defines a second opening 1371 which is located at an intermediate position between the first end portion 1372 and the second end portion 1373 of the first housing 137. The second housing 138 defines a third opening 1381 which is located at an intermediate position between the third end portion 1382 and the fourth end portion 1383 of the second housing 138. A fourth opening 1391 is defined in the corresponding position of the protective case 139 and aligned with the second opening 1371. A fifth opening (not shown) is defined in the corresponding position of the protective case 139 and aligned with the third opening 1381. The first charging interface 1331 is coupled to the first housing 137 and protrudes from the second opening 1371 of the first housing 137 and the fourth opening 1391 of the protective case 139. The second charging interface 1332 is coupled to the second housing 138 and protrudes from the third opening 1381 of the second housing 138 and the fifth opening of the protective case 139.

In the present embodiment, the interface connecting assembly 13 further includes a circuit board 141, a lead wire 142, a battery 143, and a charging port 144. The first charging interface 1331 and the second charging interface 1332 are coupled to the circuit board 141 through the lead wire 142. The battery 143 is coupled to the circuit board 141 for charging the electronic device 2 coupled to the first charging interface 1331 or the second charging interface 1332. The charging port 144 is coupled to the circuit board 141, and an external power source (not shown) can be coupled to the charging port 144 to supply electric power to the battery 143.

Referring to FIG. 4, an embodiment of the operation of the adjustable charging base 1 is shown. When using the first charging interface 1331 to charge the electronic device 2, the first charging interface 1331 extends through the first opening 114 of the upper cover 11. Due to a restraint of the protective case 139 on the first housing 137 and the second housing 138 and the gravitational force of the first housing 137, the resilient members 1400 and 1401 between the first housing 137 and the second housing 138 are in a compressed state. The first charging interface 1331/second charging interface 1332 can be moved along a plane of the holding section 111 to adjust a position of the first charging interface 1331/second charging interface 1332 extending through the first opening 114.

When it is needed to use the second charging interface 1332 to charge the electronic device 2, the knob 136 can be turned to drive the second roller 135 and the sliding rail 131 to rotate, for example, 180 degrees along the arcuate groove 1232 of the boss 1231 so that the second charging interface 1332 extends through the first opening 114. The natural inclination of the electronic device 2 causes the first charging interface 1331/second interface 1332 to drive the corresponding first connecting shaft 1333/second connecting shaft 1334 to rotate, thereby causing the corresponding resilient members 140 to compress and the other corresponding resilient members 140 to decompress or relax.

The adjustable charging base 1 has a simple structure, and switching between the first charging interface 1331 and the second charging interface 1332 and sliding the first charging interface 1331/second charging interface 1332 along the sliding block 132 can be realized, and the charging of various types of electronic devices 2 can be achieved. In addition, due to the structural characteristics of the interface connecting apparatus 13, when the electronic device 2 is coupled to the adjustable charging base 1, the electronic device 2 can be supported on the supporting section 112 of the upper cover 11 to allow a user to view the electronic device 2 while charging.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An adjustable charging base for charging an electronic device comprising:
an upper cover defining a first opening therein and configured for holding an electronic device in a first receiving space therein;
a lower cover having a second receiving space defined therein;
an interface connecting assembly comprising a first charging interface and a second charging interface, and being rotationally received in the second receiving space;
wherein the interface connecting assembly is rotatable to provide one of the first and second charging interfaces through the first opening of the upper cover.

2. The adjustable charging base of claim 1, wherein the upper cover comprises a holding section and a supporting section extending upwardly from the holding section, the first opening is defined in the holding section, the first receiving space is defined between the holding section and the resting section for placing an electronic device to plug the first or second charging interface, the supporting section supports the electronic device at an angle while the electronic device is plugged by the first or second charging interface, the plurality of resilient members adjacent to the supporting section are deformed when the electronic device is supported by the supporting section.

3. The adjustable charging base of claim 2, wherein the interface connecting assembly comprises a sliding rail, a sliding block, the first charging interface, and the second charging interface; the sliding block is slidably coupled to the sliding rail; the first and second charging interfaces are coupled to the sliding block; a planar position of the first or second charging interface extending through the first opening of the upper cover is adjustable by sliding the sliding block along the sliding rail.

4. The adjustable charging base of claim 3, wherein the lower cover comprises a first sidewall and a second sidewall opposite to the first sidewall; the sliding rail is coupled between the first sidewall and the second sidewall.

5. The adjustable charging base of claim 4, wherein the sliding block comprises a first side and a second side, the first charging interface is located on the first side, and the second charging interface is located on the second side.

6. The adjustable charging base of claim 5, wherein the first side of the sliding block defines a first U-shaped groove, the second side of the sliding block defines a second U-shaped groove, each of the first charging interface and the second charging interface comprises a shaft, the first charging interface is rotationally coupled by the shaft between opposite sidewalls of the first charging interface, and the second charging interface is rotationally coupled by the shaft between opposite sidewalls of the second charging interface.

7. The adjustable charging base of claim 6, wherein the interface connecting assembly comprises a first roller and a second roller; a first through hole is defined in the first sidewall, the first roller is rotationally received in the first through hole; the second sidewall forms a boss, an arcuate groove being defined in the boss; one side of the second roller comprises a handle, the handle is received in the arcuate groove; the sliding rail comprises a first end and a second end, the first end is coupled to the first roller, and the second end is coupled to the second roller.

8. The adjustable charging base of claim 7, wherein the interface connecting assembly further comprises a knob, the second sidewall defines a second through hole, the knob extends through the second through hole and is coupled with the second roller, the knob is configured to rotate the second roller and the interface connecting assembly, the handle of the second roller rotates along the arcuate groove.

9. The adjustable charging base of claim 8, wherein the boss is arcuate, the boss and the arcuate groove each has an arc of 180 degrees.

10. The adjustable charging base of claim 9, wherein the interface connecting assembly further comprises a first housing defining a second opening, a second housing defining a third opening, and a plurality of resilient members coupling the first housing to the second housing, the first housing and the second housing cooperatively define a third receiving space for receiving the sliding block therein, the first charging interface is coupled to the first housing and extends through the second opening, and the second charging interface is coupled to the second housing and extends through the third opening.

11. The adjustable charging base of claim 10, wherein the interface connecting assembly further comprises a protective shell arranged on the first housing and the second housing, the protective shell defines a fourth opening aligned with the second opening of the first housing, the protective shell defines a fifth opening aligned with the third opening of the second housing, the first charging interface extends through the fourth opening, and the second charging interface extends through the fifth opening.

12. The adjustable charging base of claim 11, wherein the interface connecting assembly further comprises a circuit board, a pair of lead wires, a battery, and a charging port; each of the first charging interface and the second charging interface is electrically coupled to the circuit board through a corresponding one of the pair of lead wires; the battery is electrically coupled to the circuit board; the charging port is electrically coupled to the circuit board; the charging port receives power from an external source and provides the power to the battery.
